(19) United States
(12) Patent Application Publication
(10) Pub. No.: US 2026/0368441 A1
(43) Pub. Date: Nov. 19, 2026

(54) METHOD FOR MAKING ASSET, CONTENT, OR TEMPLATE RECOMMENDATIONS, THROUGH KEYWORDS AND USER EXPERIENCE, AND DEVICE THEREFOR

(71) Applicant: FAMPPY INC., Anyang-si Gyeonggi-do (KR)

(72) Inventors: Hae Jin Park, Guro-gu Seoul (KR); Sang Yong Lee, Guro-gu Seoul (KR); Yong Sung Kim, Namyangju-si Gyeonggi-do (KR); Bo Myeong Kim, Dongjak-gu Seoul (KR)

(73) Assignee: FAMPPY INC., Anyang-si Gyeonggi-do (KR)

(21) Appl. No.: 19/104,874

(22) PCT Filed: Nov. 15, 2023
(86) PCT No.: PCT/KR2023/018398

§ 371 Date: Feb. 19, 2025

(30) Foreign Application Priority Data
Jul. 26, 2023 (KR) 10-2023-0097328

(51) Int. Cl. G06F 40/40; G06T 7/90

(52) U.S. Cl. CPC G06F 40/40; G06T 7/90; G06T 2200/24; G06T 2207/10024

(57) ABSTRACT

The present disclosure relates to a method for recommending an asset, content, or a template to a user by a recommendation device, the method includes the steps of: receiving a sentence for receiving an asset, the content, or the template recommendation from the user; generating a keyword for recommending the asset, the content, or the template on the basis of the sentence; generating user characteristic data on the basis of history information of content used by the user through a platform, 2) information on components of the content produced by the user, and 3) information on content currently being produced by the user; and generating a list of the asset, the content, or the template recommended for the user on the basis of the keyword and the user characteristic data.

### TECHNICAL FIELD

The present specification relates to a method for utilizing keywords, the characteristics of content being used and produced, and the characteristics of real-time data, so as to overcome the problems of a technique for providing customized content by analyzing an interest of a user.

### BACKGROUND ART

A user activity-based recommendation system is a service for recommending content based on activity history information of a user. However, this method may cause problems such as bias enhancement, limitation of information, and lack of diversity. For example, bias enhancement may occur by determining the similarity of content in consideration of only specific types of information. In addition, since the limitation of information is based only on the user activity information, there is a problem in that new content or content with insufficient activity information cannot be recommended. As a result, the recommendation system may fail to provide various information and lack diversity.

### CONTENTS OF INVENTION

### Technical Challenge

An object of the present specification is to accumulate information according to detailed items and configurations of content currently being worked on by a user in real-time.

In addition, an object of the present specification is to enhance recommendation information of content and consider characteristics of content according to a user's search or activity information.

In addition, an object of the present specification is to configure a system for recommending content with various keywords using a large-scale language model.

The technical problems to be achieved by the present specification are not limited to the technical problems mentioned above, and other technical problems not mentioned will be clearly understood by those skilled in the art from the following detailed description of the present specification.

### Technical Solution

According to an aspect of the present invention, a method for recommending an asset, content, or an template to a user by a recommendation device comprises the steps of: receiving a sentence for receiving recommendation of the asset, the content, or the template from the user; generating a keyword for recommending the asset, the content, or the template based on the sentence; generating user characteristic data based on 1) history information of content used by the user through a platform, 2) information of components of content produced by the user, and 3) information of content currently produced by the user; and generating a list of the asset, the content, or the template recommended to the user based on the keyword and the user characteristic data.

In addition, the generating of the user characteristic data may comprise: acquiring an asset image based on history information of the content, information about components of the content produced by the user, and information about content currently being produced by the user; generating an image caption based on the asset image; generating text related to the asset image based on the image caption; extracting an atmosphere of the text based on the text; extracting a color based on the asset image; extracting an atmosphere of the color based on the extracted color; extracting an asset characteristic related to the asset image based on the atmosphere of the text, the color, and the atmosphere of the color; and generating the user characteristic data based on the asset characteristic.

In addition, the method may further comprise: extracting a language atmosphere and acquiring an thumbnail image, based on history information of the content, information of components of the content produced by the user, and information of content currently being produced by the user; extracting a color of the thumbnail image and an atmosphere of the color, based on the thumbnail image; extracting an asset characteristic comprised in content related to the thumbnail; extracting a content characteristic, based on the language atmosphere, the color of the image, the atmosphere of the color, and the asset characteristic comprised in content related to the thumbnail; and generating the user characteristic data, based on the content characteristic.

In addition, the generating of the keyword may comprise: converting the sentence into a story-type text through a language model; converting the story-type text into a synopsis including 1) a background, 2) a main character, and 3) a main element through the language model; converting the synopsis into sentence data associated with language-based data comprised in the asset, the content, or the information related to the template through the language model; and generating the keyword based on the sentence data.

In addition, the method may further comprise: applying a weight related to the user's preference to the asset characteristic and the content characteristic; and generating the user characteristic data based on the weight.

In addition, the method may further comprise displaying the asset, the content, or a list of the template to the user through the platform.

In addition, the method may further comprise displaying the asset, the content, or a list of the template to the user through the hybrid production device.

According to another aspect of the present specification, there is provided a recommendation device for recommending an asset, a content, or an template to a user, the recommendation device including: a communication unit; an memory including a language model; and a processor configured to functionally control the communication unit and the memory, wherein the processor is configured to: receive, from the user, an input of a sentence for recommending the asset, the content, or the template; generate a keyword for recommending the asset, the content, or the template, based on the sentence; generate user characteristic data, based on 1) history information of content used by the user through a platform, 2) information of components of content produced by the user, and 3) information about content currently being produced by the user; and generate a list of the asset, the content, or the template that may be recommended to the user, based on the keyword and the user characteristic data.

### Effect of Invention

According to an embodiment of the present specification, information according to detailed items and configurations of content currently being worked on by a user may be accumulated in real-time.

In addition, according to an embodiment of the present specification, it is possible to strengthen the recommendation information of the content and consider the characteristics of the content according to the user's search or activity information.

In addition, according to an embodiment of the present specification, it is possible to configure a system for recommending content with various keywords using a large-scale language model.

The effects obtainable in the present specification are not limited to the effects mentioned above, and other effects not mentioned will be clearly understood by those skilled in the art to which the present specification pertains from the following description.

### BRIEF DESCRIPTION OF DRAWING

FIG. 1 is a block diagram for describing an electronic device associated with the present specification.

FIG. 2 is an embodiment to which the present specification may be applied.

FIG. 3 is an example of page generation to which the present specification may be applied.

FIG. 4 is an example of a controller 400 that may be applied herein.

FIG. 5 is an example of a page list to which the present specification may be applied.

FIG. 6 is an example of elements to which the present specification may be applied.

FIG. 7 is an example of event detection of the convergence manufacturing device to which the present specification may be applied.

FIG. 8 is an example of a result execution method to which the present specification may be applied.

FIG. 9 is an example of element management to which the present specification may be applied.

FIGS. 10 and 11 are examples of element uploads to which the present specification may be applied.

FIG. 12 is a block diagram of an AI device according to an embodiment of the present specification.

FIG. 13 is an example of a recommendation method pipeline to which the present specification may be applied.

FIG. 14 is an example of visual coding to which the present specification may be applied.

FIG. 15 is an embodiment of a recommendation device to which the present specification may be applied.

FIG. 16 is an example of a sentence input to which the present specification may be applied.

FIG. 17 is an example of a recommendation method to which the present specification may be applied.

FIG. 18 is an example of user characteristic data generation to which the present specification may be applied.

FIGS. 19 and 20 illustrate the collection of characteristic data that may be comprised in a database to which the present specification may be applied.

FIGS. 21 and 22 are examples of information related to contents to which the present specification may be applied.

FIG. 23 is an example of asset property extraction to which the present specification may be applied.

FIG. 24 is an example of content/template characteristic extraction to which the present specification may be applied.

FIG. 25 is yet another embodiment of a recommendation device to which the present specification may be applied.

FIG. 26 is an example of a platform to which the present specification may be applied.

FIG. 27 is an example of a convergence manufacturing device to which the present specification may be applied.

The accompanying drawings, which are comprised as part of the detailed description to assist in understanding of the present specification, provide embodiments of the present specification and describe the technical features of the present specification together with the detailed description.

### FORM FOR PRACTICE OF INVENTION

Hereinafter, embodiments disclosed in the present specification will be described in detail with reference to the accompanying drawings, but the same or similar components are given the same reference numerals regardless of reference numerals, and redundant descriptions thereof will be omitted. Suffixes “module” and “unit” for components used in the following description are given or mixed in consideration of only ease of writing the specification, and do not have distinct meanings or roles by themselves. In addition, in describing the embodiments disclosed in the present specification, when it is determined that a detailed description of a related known technology may obscure the gist of the embodiments disclosed in the present specification, the detailed description thereof will be omitted. In addition, the accompanying drawings are only for easy understanding of the embodiments disclosed in the present specification, and the technical spirit disclosed in the present specification is not limited by the accompanying drawings, and it should be understood that all changes, equivalents, and substitutes comprised in the spirit and scope of the present specification are comprised.

Terms including ordinal numbers such as first and second may be used to describe various components, but the components are not limited by the terms. The terms are used only for the purpose of distinguishing one component from another component.

It will be understood that when an element is referred to as being “connected” or “coupled” to another element, the element may be directly connected or coupled to the other element or intervening elements may be present. On the other hand, when an element is referred to as being “directly connected” or “directly coupled” to another element, it should be understood that there is no intervening element therebetween.

Singular expressions comprise plural expressions unless the context clearly indicates otherwise.

In the present application, terms such as “comprise” or “have” are intended to designate the presence of features, numbers, steps, operations, components, parts, or combinations thereof described in the specification, and it should be understood that they do not preclude the possibility of the presence or addition of one or more other features, numbers, steps, operations, components, parts, or combinations thereof.

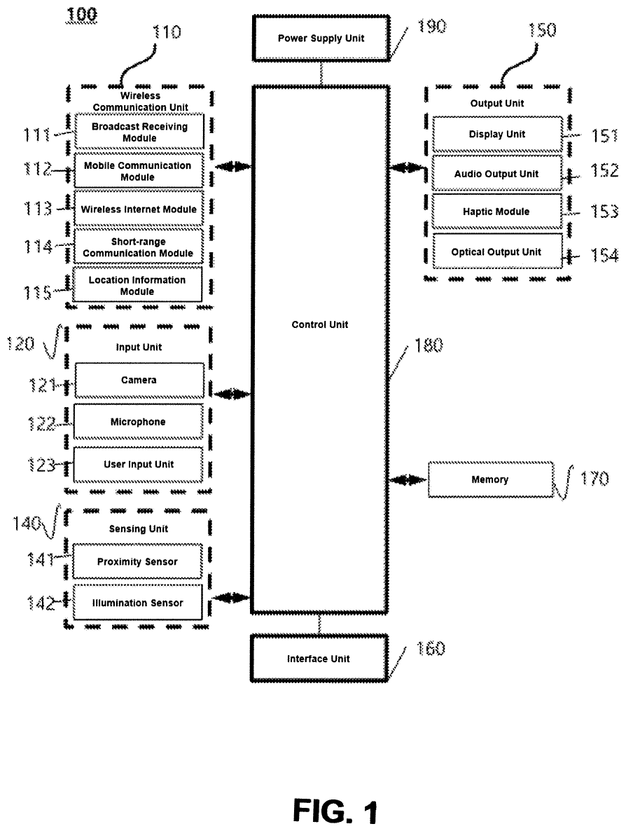

FIG. 1 is a block diagram for describing an electronic device associated with the present specification.

The electronic device 100 may comprise a wireless communication unit 110, an input unit 120, a sensing unit 140, an output unit 150, an interface unit 160, a memory 170, a control unit 180, and a power supply unit 190. The components shown in FIG. 1 are not essential for implementing an electronic device, and thus the electronic device described herein may have more or fewer components than those listed above.

In more detail, the wireless communication unit 110 of those components may typically comprise one or more modules which permit wireless communication between the electronic device 100 and a wireless communication system, between the electronic device 100 and another electronic device 100, or between the electronic device 100 and an external server. Further, the wireless communication unit 110 typically comprises one or more modules which connect the electronic device 100 to one or more networks.

The wireless communication unit 110 may comprise at least one of a broadcast receiving module 111, a mobile communication module 112, a wireless Internet module 113, a short-range communication module 114, and a location information module 115.

The input unit 120 may comprise a camera 121 or an image input unit for inputting an image signal, a microphone 122 or an audio input unit for inputting an audio signal, and a user input unit 123 for receiving information from a user, for example, a touch key, a mechanical key, and the like. Voice data or image data collected by the input unit 120 may be analyzed and processed as a control command of the user.

The sensing unit 140 may comprise one or more sensors for sensing at least one of information in the electronic device, surrounding environment information around the electronic device, and user information. For example, the sensing unit 140 may comprise at least one of a proximity sensor 141, a illumination sensor 142, a touch sensor, an acceleration sensor, a magnetic sensor, a G-sensor, a gyroscope sensor, a motion sensor, an RGB sensor, an infrared sensor, a finger scan sensor, a ultrasonic sensor, an optical sensor, for example, a camera 121, a microphone 122, a battery gauge, an environmental sensor, a chemical sensor, for example, an electronic nose, a healthcare sensor, a biometric sensor, etc. Meanwhile, the electronic device disclosed in the present specification may combine and utilize information sensed by at least two or more of these sensors.

The output unit 150 is for generating an output related to visual, auditory, or tactile sense, and may comprise at least one of a display unit 151, an audio output unit 152, a haptic module 153, and an optical output unit 154. The display unit 151 may form a mutual layer structure with a touch sensor or may be integrally formed to implement a touch screen. The touch screen may provide an output interface between the electronic device 100 and a user, as well as function as the user input unit 123 which provides an input interface between the electronic device 100 and the user.

The interface unit 160 serves as a path to various types of external devices connected to the electronic device 100. The interface unit 160 may comprise at least one of a wired/wireless headset port, an external charger port, a wired/wireless data port, a memory card port memory, and port connecting a device having an identification module, an audio input/output (I/O) port, a video input/output (I/O) port, and an earphone port. The electronic device 100 may perform appropriate control related to the connected external device in response to the connection of the external device to the interface unit 160.

In addition, the memory 170 stores data supporting various functions of the electronic device 100. The memory 170 may store a plurality of application program (or applications) driven in the electronic device 100, and data and commands for the operation of the electronic device 100. At least some of the application programs may be downloaded from an external server through wireless communication. In addition, at least some of the application programs may be present on the electronic device 100 from the time of shipment for basic functions of the electronic device 100 (e.g., call reception function, call sending function, message reception function, and call sending function). The application programs may be stored in the memory 170, installed in the electronic device 100, and executed by the control unit 180 to perform an operation (or function) of the electronic device.

The control unit 180 typically controls the overall operation of the electronic device 100, in addition to the operations associated with the application programs. The control unit 180 may process signals, data, information, and the like input or output through the above-described components or drive an application program stored in the memory 170 to provide or process information or functions appropriate for the user.

In addition, the control unit 180 may control at least some of the components described with reference to FIG. 1 in order to drive the application program stored in the memory 170. Furthermore, the control unit 180 may combine and operate at least two or more of the components comprised in the electronic device 100 in order to drive the application program.

The power supply unit 190 receives external power and internal power under the control of the control unit 180 and supplies power to each component comprised in the electronic device 100. The power supply unit 190 comprises a battery, and the battery may be a built-in battery or a replaceable battery.

At least some of the components may operate in cooperation with each other to implement an operation, control, or control method of an electronic device according to various embodiments described below. Further, the operation, the control, or the control method of the electronic device may be implemented on the electronic device by driving at least one application program stored in the memory 170.

In this specification, the electronic device 100 may comprise a recommendation device, a terminal, a visual coding device, and a convergence manufacturing device.

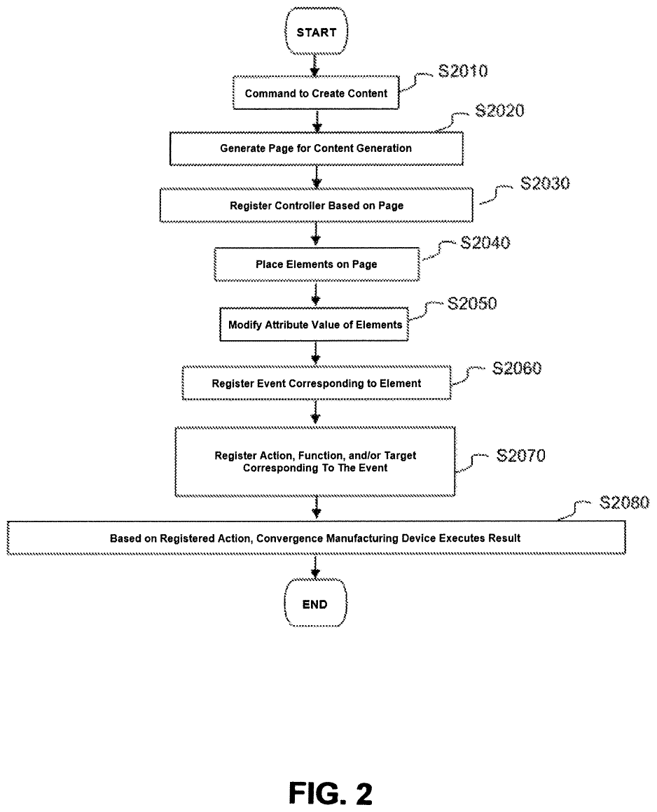

FIG. 2 is an embodiment to which the present specification may be applied.

Referring to FIG. 2, a user may communicate with the convergence manufacturing device through a terminal. For example, the terminal may be connected to the convergence manufacturing device through the WEB without a separate application, and the user may simultaneously produce 2D and 3D contents through the terminal.

The recommendation device comprises an AI device 20 to be described later and is connected to a user terminal and a convergence manufacturing device to analyze a user's tendency using meta information generated from the terminal, the platform, and the convergence manufacturing device, and recommend content, asset, and template suitable for the user by using the analysis result.

The recommendation device may assign a weight to the content activity used by the user through the platform, may analyze information of the content generated through the convergence manufacturing device, may extract characteristics, and may use the characteristics as learning data of the recommendation algorithm.

In addition, the recommendation device may extract real-time characteristics by analyzing information of content currently being worked on by the user through the convergence manufacturing device.

In addition, the recommendation device may generate JSON sentence data using a large-scale language model framework based on a sentence written in an input window by a user through a terminal. For example, the recommendation device may extract various keywords by processing sentences input by the user into a large-scale language model framework.

Using this, the recommendation device may recommend content, asset, and template to the convergence manufacturing device, and recommend template and content to the platform. In addition, the recommendation device may analyze the uploaded file to generate JSON sentence data through the language model framework and store the asset sentence data in the HTML meta-information.

The convergence manufacturing device receives a command to create content from the terminal through the WEB (S2010). For example, the content may comprise 2D and/or 3D objects.

The convergence manufacturing device generates a page for content generation (S2020). For example, the page may comprise a page that may be expressed in a 2D or 3D form, and the hybrid type manufacturing device may add and arrange a predefined asset or template to each page to configure a screen. In more detail, an event may be registered in the added element, and an interaction with the content user may be added. Through this, the user may produce immersive and creative content

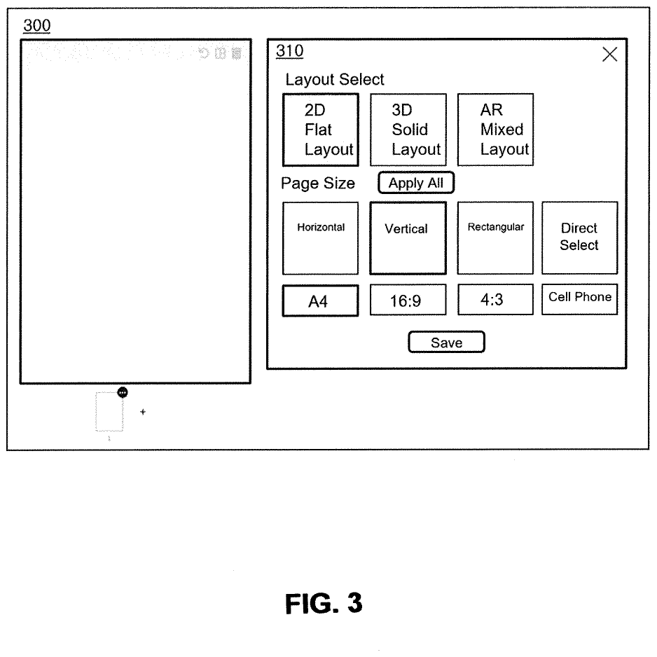

FIG. 3 is an example of page generation to which the present specification may be applied.

Referring to FIG. 3, a user may be provided with a page display screen 300 from the convergence manufacturing device through a terminal. For example, one piece of content may comprise one or more pages. In addition, the user may 2D or 3D change the form of the page through the layout selection window 310 that may be displayed on the page display screen 300 and may separately add a virtual space having a special function according to the request of the content user such as the AR mode. The convergence manufacturing device may register a separate controller 400 according to the type of the page. In addition, the user may change the size and ratio of the page through the layout selection window 310.

Referring back to FIG. 2, the convergence manufacturing device registers the controller 400 based on the page (S2030). For example, the convergence manufacturing device may register the controller 400 capable of controlling and interacting with an element according to the shape of the page.

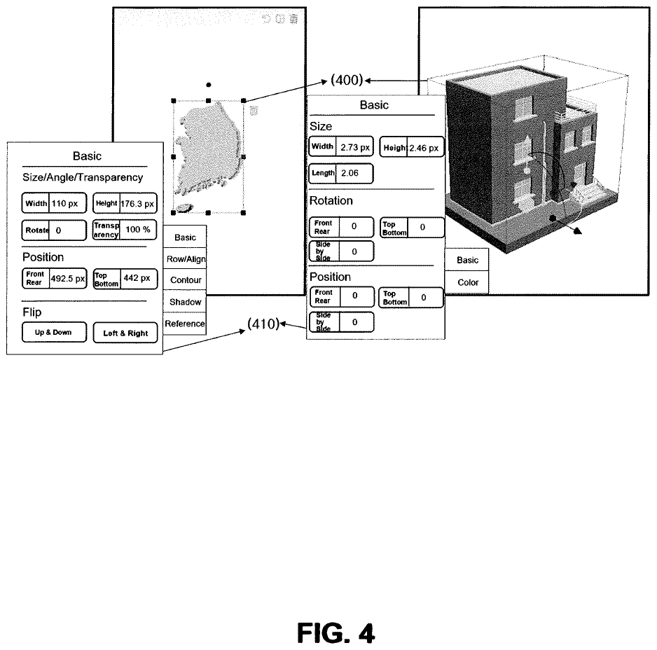

FIG. 4 is an example of a controller 400 that may be applied herein.

Referring to FIG. 4, when a user selects an element through a terminal, an attribute suitable for the element is displayed on an attribute window 410, the convergence manufacturing device displays a registered controller 400, and the user may easily edit the attribute using a mouse or a touch using the controller 400, and for example, the user may input an accurate numerical value in the attribute window 410 to precisely modify attribute values of the element. The user may add a tab to the attribute window 410 to perform an additional connected function. For example, the additional connected functions may comprise a source of a producer of the element, media playback information, or the like.

Referring back to FIG. 2, the convergence manufacturing device places elements on a page (S2040). For example, the convergence manufacturing device may arrange predefined elements/template and/or additionally uploaded elements according to a page shape.

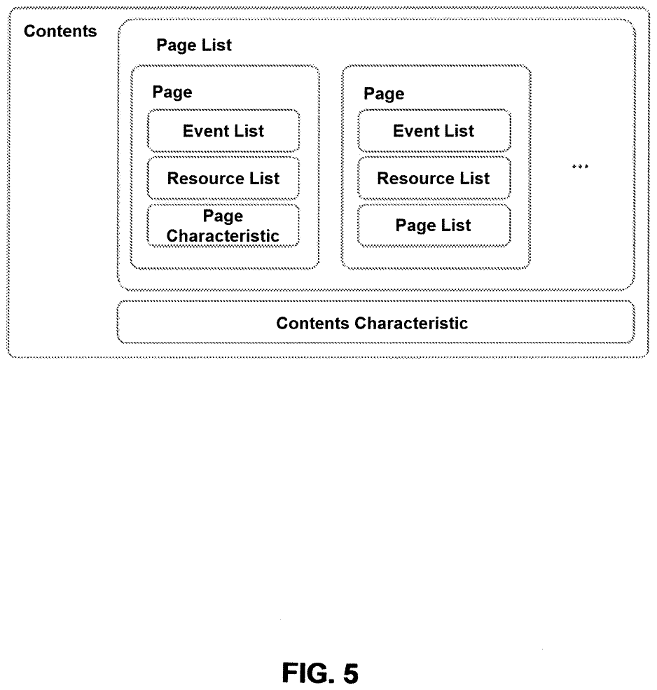

FIG. 5 is an example of a page list to which the present specification may be applied.

Referring to FIG. 5, one content is composed of a bundle of several pages (screens), and 2D and 3D screens may be selected according to a user's request.

For example, a page comprises (1) a property of the page and (2) an event list, and (3) a resource list. More specifically, the event list comprises information of events allocated to the element, and the resource list comprises information of elements added to the page.

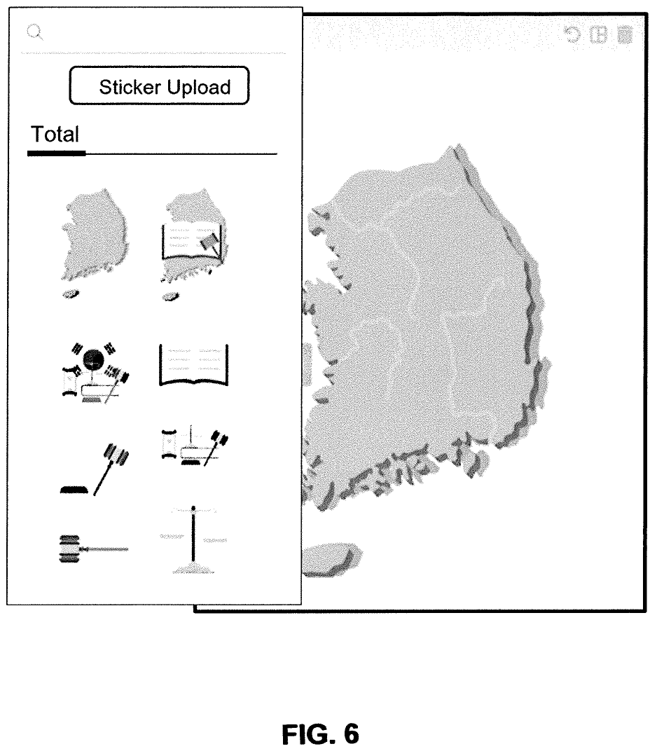

FIG. 6 is an example of elements to which the present specification may be applied.

Referring to FIG. 6, the convergence manufacturing device may provide a predefined element/template to a user through a terminal according to a page shape. In addition, the user may additionally upload and place elements.

Referring back to FIG. 2, the convergence manufacturing device modifies attribute values of elements (S2050).

For example, when the user selects an element arranged on the page display screen 300, the convergence manufacturing device displays an attribute window 410 corresponding to the element, and the user may modify the attribute value through a mouse, a touch, a numerical input, or the like by using the controller 400 registered based on the page.

The convergence manufacturing device registers an event corresponding to the element (S2060). For example, an event may comprise a set of “actions” and “outcomes”. In more detail, the action may define a condition in which an event occurs. For example, an “action” is a condition for performing a function, and may comprise various types of events or calls such as a keyboard event, a mouse/touch event, a gesture event, a region event, a value event, and a call event.

In addition, the result may comprise “function” and “subject”.

In more detail, when an event is activated, the “function” may define a property change and specific actions to be performed on the “target” that is the purpose of the function, and may comprise a basic property of an element such as a position, a size, a rotation, and transparency, and a control function for a media element such as viewing, hiding, playback, stop, and pause. In addition, a camera, a GPS, an accelerometer, and the like of the user terminal for utilizing information of the external environment may be comprised.

The convergence manufacturing device registers an action, a function, and/or a target corresponding to the event (S2070). For example, the convergence manufacturing device may register an action, a function, and/or a target based on the attribute value of the element.

When an event for an element is detected based on the registered action, the convergence manufacturing device executes the result (S2080).

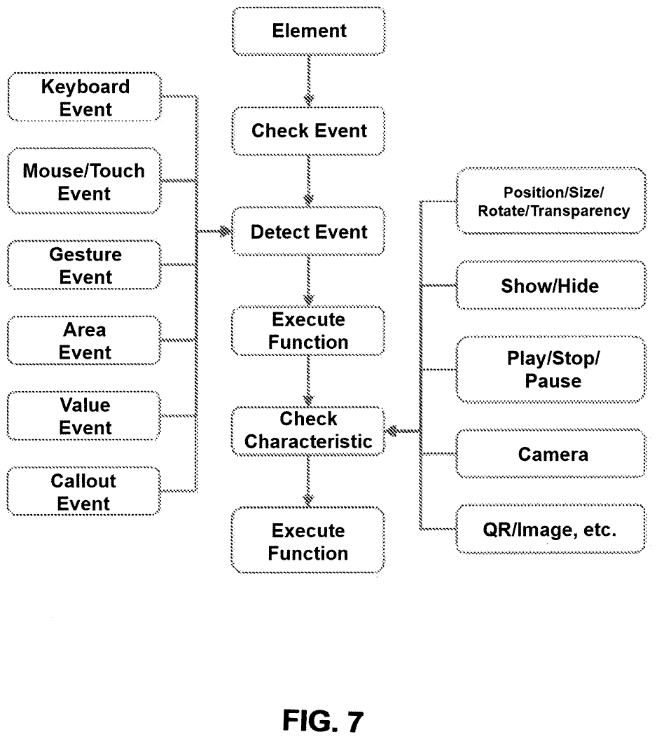

FIG. 7 is an example of event detection of the convergence manufacturing device to which the present specification may be applied.

Referring to FIG. 7, the convergence manufacturing device may check an event corresponding to an element, monitor the event, and detect the event. When an event is detected, the convergence manufacturing device may identify an attribute and execute a result based on the function and the attribute in order to execute a function corresponding to the event.

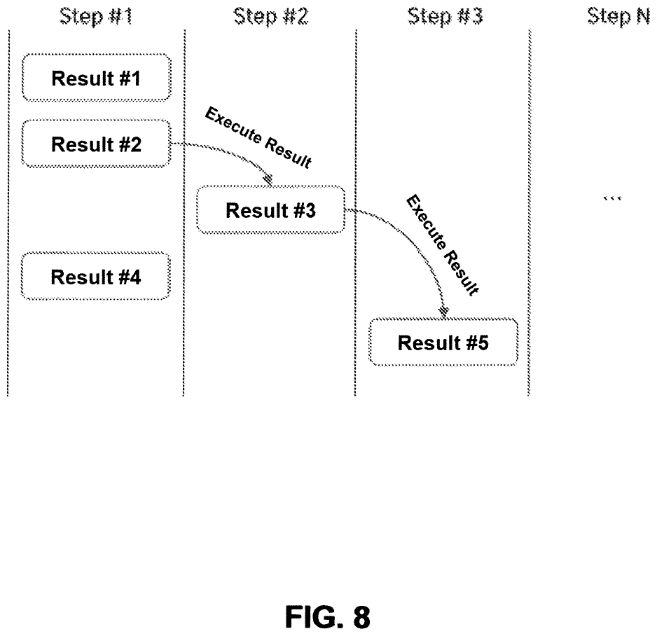

FIG. 8 is an example of a result execution method to which the present specification may be applied.

Referring to FIG. 8, the convergence manufacturing device may simultaneously execute the “result”, and the lower “result” may be connected to the upper “result” to be continuously executed. In addition, the connection of the “result” is not limited, and a continuous function may be performed in the next step using the execution result of the upper “result”. Unlike an execution method that is simply driven by one timeline, the result execution method may provide a user with the same environment as an actual programming technique in relation to an operation of an element and may help the user to naturally learn about a programming environment.

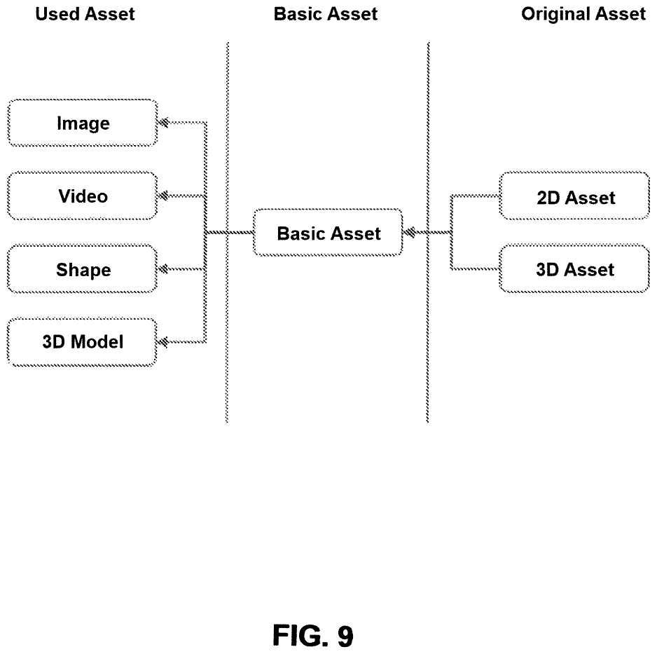

FIG. 9 is an example of element management to which the present specification may be applied.

Referring to FIG. 9, since the 2D type element and the 3D type element have different attributes, it is difficult for the convergence manufacturing device to control the elements in the same manner. Therefore, the convergence manufacturing device manages elements to surround 2D-type elements and 3D-type elements through an object called a “basic element” and to expand to “use elements” used in the authoring tool of the convergence manufacturing device based on the “basic element”. For example, the functionality of a “use element” can be configured to control and use characteristics of a “raw element”. In more detail, in FIG. 9, the “use element” is exemplified as an image, a video, a figure, and a 3D model, but if it is advantageous to control and display characteristics of a 2D element and a 3D element, it may be displayed as a “use element”.

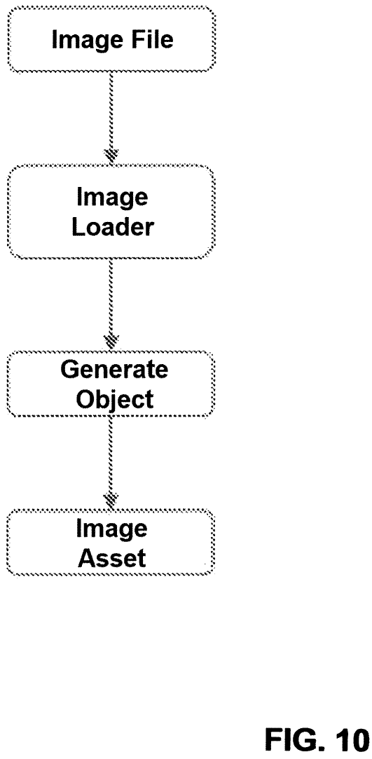

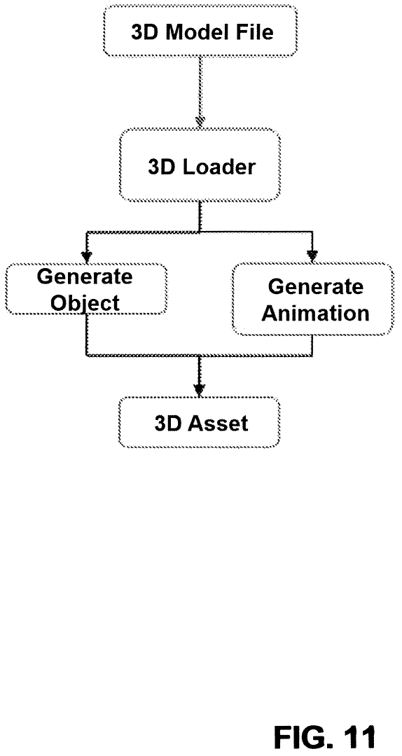

FIGS. 10 and 11 are examples of element uploads to which the present specification may be applied.

Referring to FIGS. 10 and 11, the convergence manufacturing device (or platform) loads the uploaded element file through the loader and registers the object of the loaded element file in the “use element” that may correspond to the loader. The convergence manufacturing device may arrange the uploaded element by using the registered “used element”.

Referring to FIG. 10, when the uploaded element file is an image file, the convergence manufacturing device may load the image file through the image loader and register an object of the loaded image file as an image element.

Referring to FIG. 11, when the uploaded element file is a 3D model file, the convergence manufacturing device may load the 3D model file through the 3D loader, generate an object of the loaded 3D model file, generate an animation, add the animation to the generated object, and register the object as a 3D element.

For example, when the uploaded element file is a video file, the convergence manufacturing device may generate an HTMLVideoElement, add the HTML to a screen, and register the object in a “use element” to control the same.

One content may comprise several pages, and each of the pages may comprise “resourceManager” that manages elements and “eventManager” that manages operation events.

Since the elements arranged on the page have a separate depth, the convergence manufacturing device may adjust the exposure order of the elements on the screen by adjusting the depth according to the user's needs.

For example, when an element is arranged, the convergence manufacturing device registers the element in the Resource Manager of the corresponding page and may manage the element through changes in attributes, states, etc., registration, deletion, etc. The Resource manager may call a connected function according to a change of the resource based on the resource list by generating an event for a change as well as management of the disposed element.

When the element is added, the convergence manufacturing device adds the element to the management list in order to control the element through the controller registered in the page, so that the controller may recognize and manage the element as a controllable element. Elements registered in the controller may modify or control attributes with a user's mouse, gesture, touch, external controller, etc.

In addition, a function of the Redo/Undo may be required in the process in which the user controls the element. To this end, the convergence manufacturing device may be configured to store changes in the controller in the History manager of the page to record changes in the state of the corresponding element, and to retrieve the attribute of the element from the list of changes stored in the History manager according to a request and update the current element attribute to restore or update the element state again. In the History manager, since changes are stored for each element, a memory problem may occur. Therefore, in order to prevent this, the convergence manufacturing device may limit the number of lists of changes stored according to the situation.

In addition, the convergence manufacturing device may designate a user to be shared at the time of producing the content and simultaneously perform the work. For example, when the content is initially generated, the convergence manufacturing device may generate a unique channel corresponding to the content. The convergence manufacturing device may designate a sharing user who can use a unique channel and add the user to the same channel when the user accesses the corresponding content.

Users in the same channel may exchange changes in real-time and synchronize authoring data in real-time. To this end, communication may be performed in real-time through websocket or webrtc.

However, when a new user accesses the unstored content, synchronization is performed in the state of the previous version of the content, and thus a version difference may occur. In order to prevent this, when a new user is added to the shared channel and then the content is first accessed, initial synchronization may be performed by performing overall update on the task change through a specific user among existing working users. After the initial synchronization is performed, the convergence producing device may solve a synchronization issue of unstored content through a method of sharing data on changes in real-time.

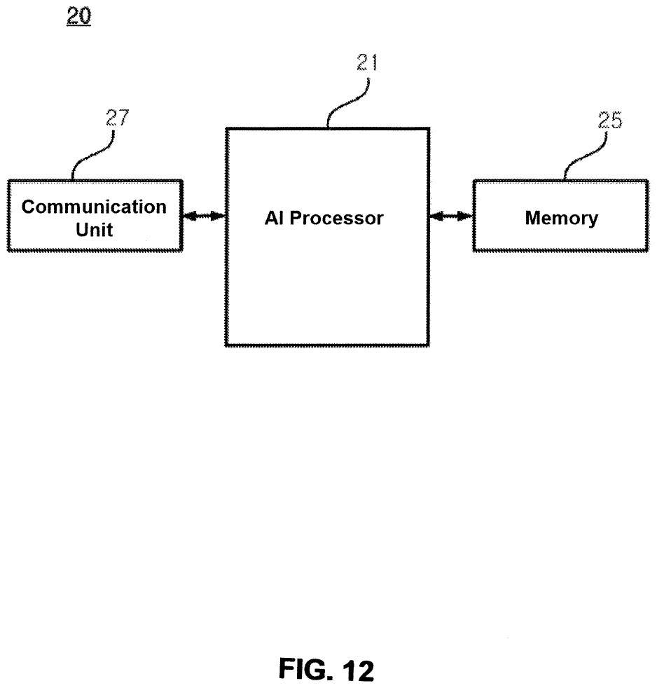

FIG. 12 is a block diagram of an AI device according to an embodiment of the present specification.

The AI device 20 may comprise an electronic device including an AI module capable of performing AI processing or a server including the AI module. In addition, the AI device 20 may be comprised as at least a part of the electronic device 100 shown in FIG. 1 and may be provided to perform at least a part of the AI processing together.

The AI device 20 may comprise an AI processor 21, a memory 25, and/or a communication unit 27.

The AI device 20 is a computing device capable of learning a neural network and may be implemented as various electronic devices such as a server, a desktop PC, a notebook PC, and a tablet PC.

The AI processor 21 may learn a neural network using a program stored in the memory 25. For example, the AI processor 21 may generate a recurrent neural networks model in which Tensorflow is utilized on the memory 25, and may train such an AI model using data that may be collected from a user terminal, a convergence manufacturing device, and the like.

For example, the trained AI model may comprise a language model, and may generate sub-models having the following tasks:
1 Content/template recommendation model: Recommend/generate customized content and template to users by utilizing data obtained by analyzing content usage information and content production information and user characteristic models
2 Element Recommendation Model: Recommendation of customized assets to content creators by utilizing user characteristic model and asset meta information
3 User characteristic analysis model: Analyzing a user's characteristic through analysis of a user's learning interest, participation, immersion, user's use, production data, etc.

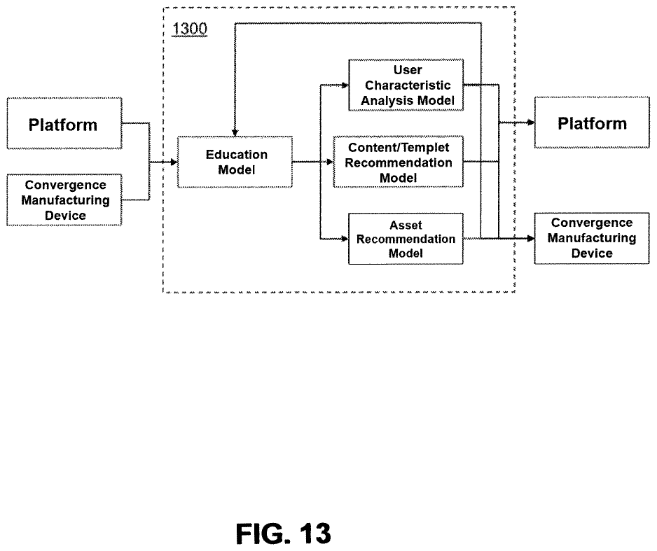

FIG. 13 is an example of a recommendation method pipeline to which the present specification may be applied.

Referring to FIG. 13, an AI model 1300 may be trained using data collected from a platform and a convergence manufacturing device.

For example, the platform may be provided to a terminal through a WEB and may be connected to a convergence manufacturing device to provide a content production environment to a user. In addition, content created by other users can be displayed, and a search function for the same can be provided. In addition, the platform and the convergence manufacturing device can provide a user with a template which can be used in a content production environment, and a search function therefore.

The trained AI model may generate 1) a user characteristic analysis model, 2) a content/template recommendation model, and 3) an element recommendation model. The user's characteristics output by the user characteristic analysis model may be used for training the AI model 1300.

In addition, the content/template recommendation model may receive a sentence from a user, convert the sentence into JSON-type sentence data, and provide automatically generated content and template to the user through a platform and a convergence manufacturing device.

In addition, the element recommendation model may recommend the asset to the user through the convergence manufacturing device using sentence data in the form of JSON.

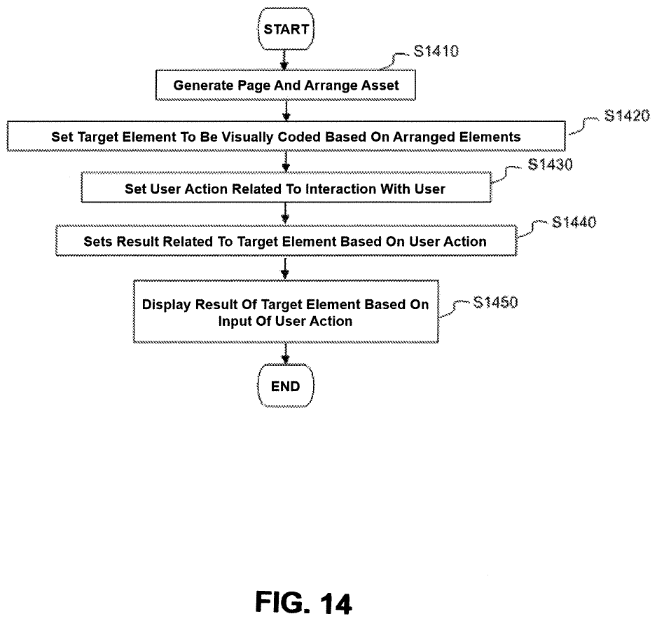

FIG. 14 is an example of visual coding to which the present specification may be applied.

Referring to FIG. 14, a user may communicate with a visual coding device through a terminal. For example, the convergence manufacturing device may comprise a visual coding device.

In addition, the terminal may be connected to the visual coding device through the WEB without a separate application, and the user may produce content through visual coding through the terminal.

The terminal generates a page for visual coding and arranges an asset in the page (S1410). For example, the terminal may display a list of elements and/or a template including the elements to the user. The user may select an element to be placed on the page in the template.

The terminal sets a target element to be visually coded based on the arranged elements (S1420). For example, the user may select a target element by clicking the target element from among elements arranged on the page.

The terminal sets a user action related to the interaction with the user (S1430). For example, the user action may be a condition for an event of the target element to occur.

The terminal sets a result related to the target element based on the user action (S1440). For example, the result may refer to an operation performed in relation to the target element when the terminal receives an input corresponding to a user action from the user. The result may comprise a “function” that controls the size, position, and state value of the target element, an “operation” to compute variables related to the target element, and a “function page” indicating the movement of the page.

The terminal displays the result of the target element based on the input of the user action (S1450). For example, when a click of the target element is received from the user once, the terminal may move the target element for one second or display a screen moved to another page as a result.

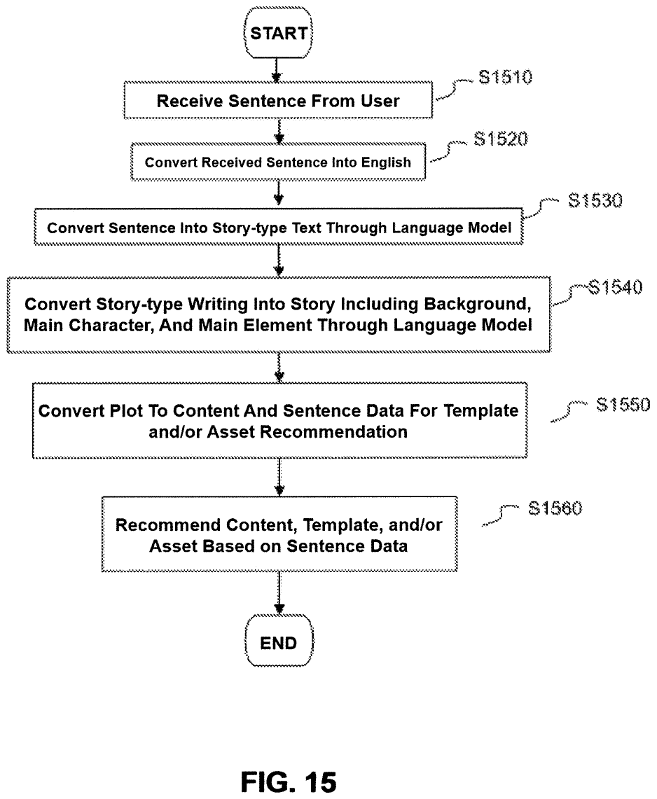

FIG. 15 is an embodiment of a recommendation device to which the present specification may be applied.

Referring to FIG. 15, the recommendation device may be connected to a user terminal and a convergence manufacturing device, learn through collected data, and provide an output value predicted through the learned AI model to the platform and the convergence manufacturing device. For example, the convergence manufacturing device may comprise an authoring tool for creating content.

The recommendation device receives a sentence from a user through the convergence manufacturing device and/or the platform (S1510). For example, the user may input a sentence for a specific topic or story for producing content to the convergence manufacturing device. In more detail, the user may input a sentence of “ [symbol] [symbol] [symbol] ” to the convergence manufacturing device. In this case, Korean may be mainly used as the input language, and the recommendation device may store the input sentence for a subsequent process.

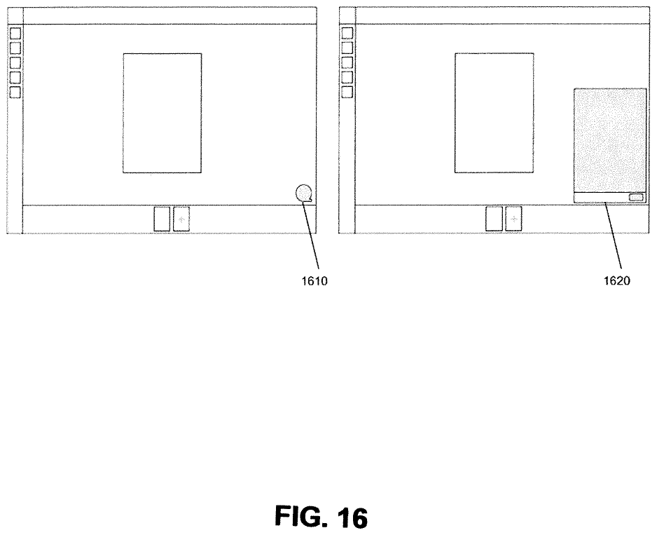

FIG. 16 is an example of a sentence input to which the present specification may be applied.

Referring to FIG. 16, a user may select a chat icon 1610 for inputting a sentence on a screen for content production. When receiving the chat icon 1610, the convergence manufacturing device may activate the chat function. Through the chat window 1620 displayed through the terminal, the user may input a sentence for creating content.

Referring back to FIG. 15, the recommendation device converts the received sentence into English (S1520). When the input sentence is a language other than English, the input sentence may be converted into English for the accuracy of the language model comprised in the recommendation device.

For example, the sentence “ [symbol] [symbol] [symbol] ” may be converted into the English sentence “Blue sky and grass with a smile”.

The recommendation device converts the sentence into a story-type text through a language model (S1530). In more detail, the template of the language model may be set to command “Write a synopsis about the “blue sky and grass with a smile” for the sentence “Blue sky and grass with a smile.””

For example, “Blue sky and grass with a smile” may be converted into a writing in the form of the story as follows:

In the enchanting world of “Blue Sky and Grass with a Smile,” we are transported to a serene and picturesque landscape where the beauty of the blue sky and lush green grass becomes a catalyst for transformation. The story revolves around Emily, a young girl grappling with the hardships of life and burdened by sorrow. However, one fateful day, she stumbles upon a hidden meadow, bathed in the golden sunlight, where the sky is a vivid shade of blue and the grass dances with an infectious joy.

As Emily immerses herself in this magical haven, she starts to notice how the vibrant hues of the sky and grass affect her mood. The brilliant blue sky acts as a gentle reminder to look beyond her troubles and find hope, while the cheerful green grass inspires her to embrace the present moment and seek happiness. Slowly but surely, a smile starts to grace Emily's face as she discovers the power of perspective and the healing balm of nature.

With each visit to the meadow, Emily's connection to the blue sky and grass deepens. She begins to cultivate a profound sense of gratitude for the beauty surrounding her, finding solace and strength in the simplicity of life's wonders. The radiant smile that forms on her lips becomes a beacon of optimism, influencing those around her and spreading contagious joy.

Through this poignant journey, “Blue Sky and Grass with a Smile” highlights the transformative power of nature and the profound impact it can have on our emotional well-being. It reminds us to find solace in the smallest of moments, to appreciate the beauty that surrounds us, and to nurture a smile that can illuminate even the darkest of days.

This is to compensate for the fact that the sentence initially input by the user has insufficient information for content creation, template, and/or asset recommendation

The recommendation device converts the story-type writing into a story including a background, a main character, and a main element through a language model (S1540). The recommendation device may analyze the story-type writing by reusing the language model and summarize it into a synopsis by summarizing it into one scene including the background, the main character, and the main element. This is to extract a core element of the content, and the recommendation device may extract a background, a main character, and a main element, which are core elements, from a lot of data comprised in a story-type article to generate a synopsis.

To this end, the template of the language model may be set to “Summarize the plot in three lines, including the background, main characters, and main elements.”

For example, the article in the form of a story illustrated in S1530 described above may be converted into the plot as follows:

In “Blue Sky and Grass with a Smile,” Emily, a young girl burdened by sorrow, discovers a hidden meadow where the vibrant blue sky and dancing green grass become catalysts for transformation. Immersed in this magical haven, she learns to find hope, embrace the present, and cultivate gratitude. Through the healing power of nature, Emily's radiant smile becomes a symbol of optimism, inspiring those around her and reminding us to appreciate life's simple wonders.

The recommendation device converts the plot to content and sentence data for template and/or asset recommendation (S1550). If necessary, the recommendation device may translate the story back to Korean. For example, the plot of the S1540 described above may be translated as follows: “ [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] ”

In addition, the recommendation device may convert the synopsis into sentence data in the JSON format based on the original word, the English word, the classification and the English classification, the importance, and the part of speech by using the language model.

The following Table 1 illustrates sentence data.

Referring to Table 1, the recommendation device may convert the writing in the form of a plot for the initial input sentence into data in the form of JSON. Data in the form of JSON may be utilized as data for content, template, and/or asset recommendation. The data in the form of JSON may comprise sentence data information such as a background, a main character, and a main element. The recommendation device recommends content, template, and/or asset based on the sentence data (S1560).

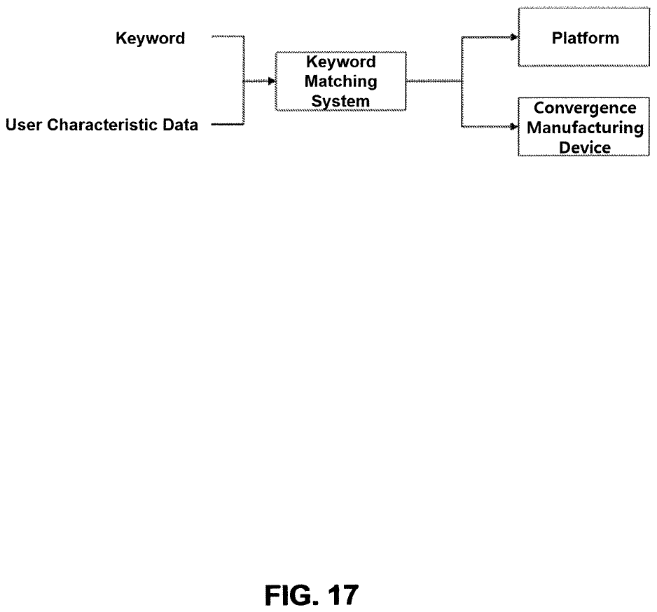

FIG. 17 is an example of a recommendation method to which the present specification may be applied.

Referring to FIG. 17, the recommending device may recommend asset, content, and/or template using not only the above-described sentence data, but also a keyword of the sentence data (e.g., “text”) and user characteristic data. For example, the keyword matching system may comprise all or some of the components of the AI model 1300.

The recommending device may configure the keyword and the user characteristic data as input data of the keyword matching system to recommend template/content to the platform and recommend template/content/asset to the convergence manufacturing device.

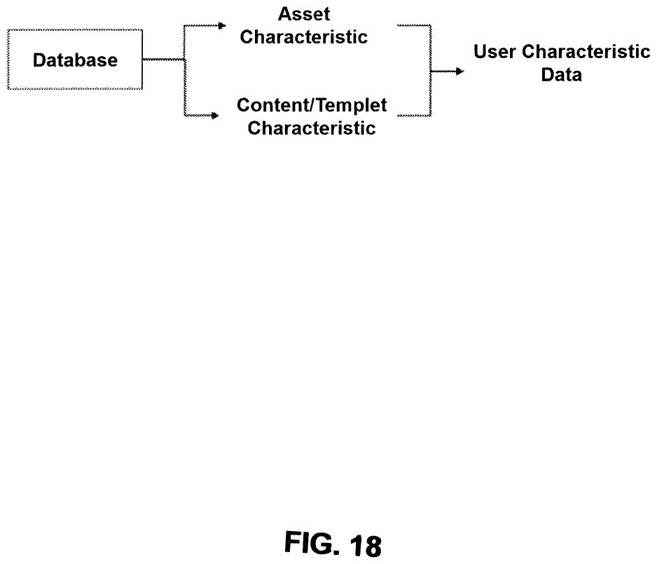

FIG. 18 is an example of user characteristic data generation to which the present specification may be applied.

Referring to FIG. 18, the recommendation device may extract the asset feature and/or the content/template feature from a database that manages data of the platform and/or the convergence manufacturing device. The recommendation device may generate user characteristic data from the extracted asset characteristic and/or content/template characteristic.

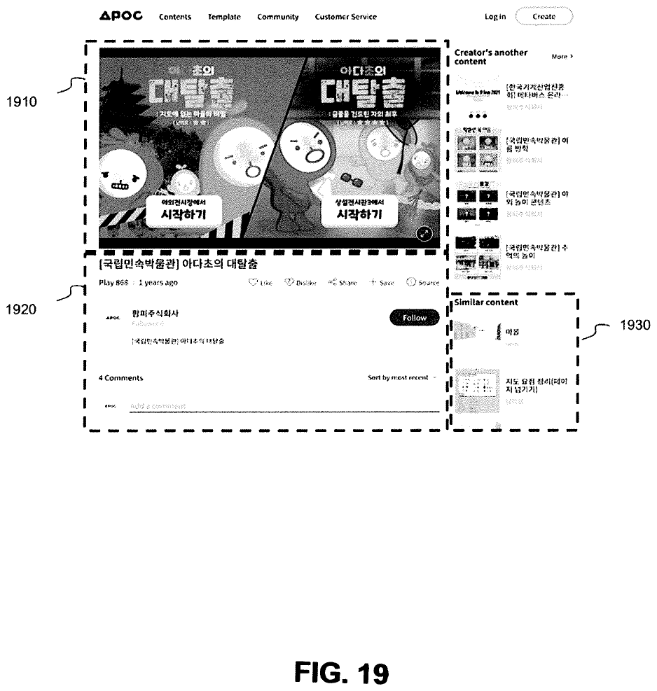

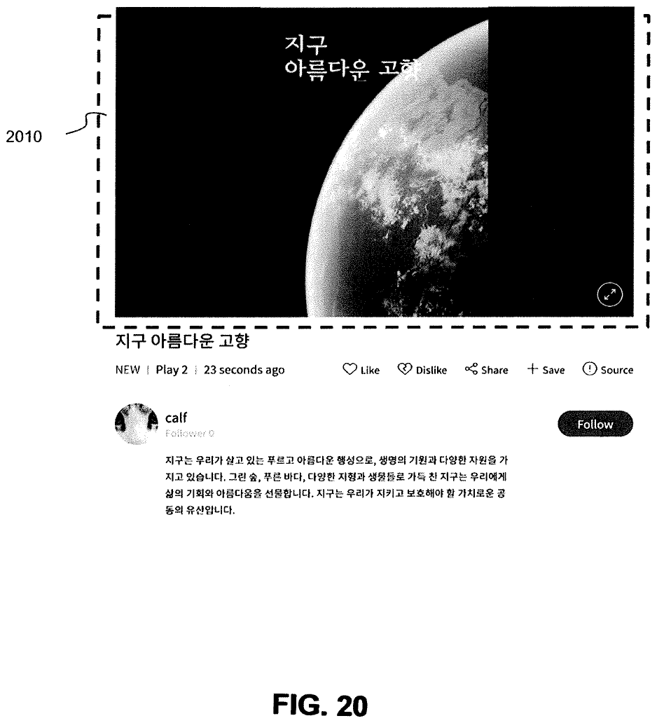

FIGS. 19 and 20 illustrate the collection of characteristic data that may be comprised in a database to which the present specification may be applied.

Referring to FIG. 19, the platform may display 1910 the produced content through the convergence manufacturing device. The platform may display 1920 information about the content together. The information about the content may be generated based on a history of the users using the content through the platform, and may comprise information such as play count, likes, dislike, storage, progress, stay time, and follow. Information on such content may be comprised and managed in a database.

Referring to FIG. 20, the platform may display 2010 content produced by the user for each user. The recommendation device may collect information on components for content produced by the user. Unlike information on content produced by other users, this may comprise information on elements used for production by the user through the convergence manufacturing device. For example, the information of the elements may comprise information such as a name, description, category, hashtag of the content, metatags of asset used for content generation, a configured operation, a background, and the like. Information on these elements may also be comprised and managed in the database.

In addition, the recommendation device may collect information on content currently being produced by the user through the convergence manufacturing device. For example, the information on the content currently being produced may comprise information on elements constituting the content being produced, such as the name, description, category, hashtag of the content, metatags of asset used for content generation, configured operation, background, and the like, and may be comprised in the database and managed.

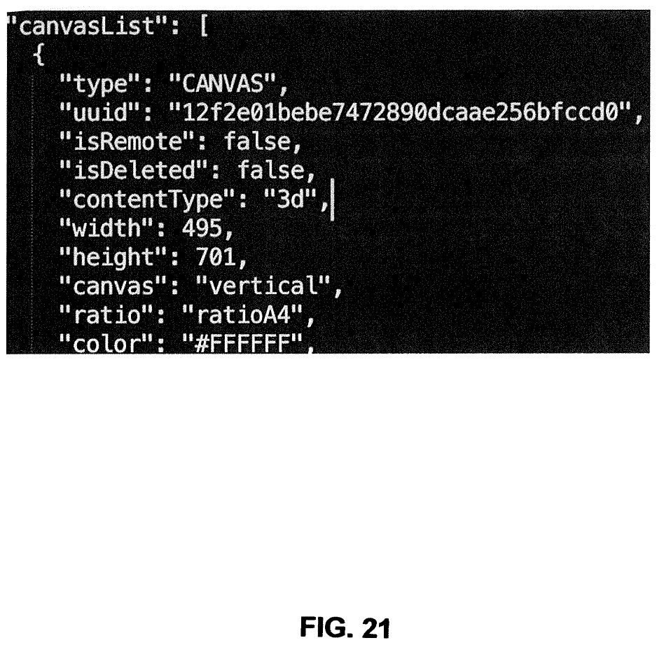

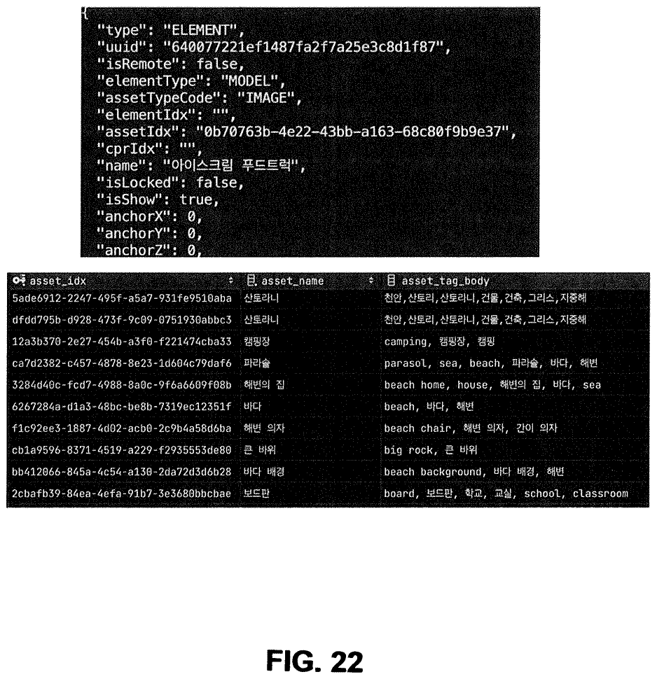

FIGS. 21 and 22 are examples of information related to contents to which the present specification may be applied.

Referring to FIG. 21, the information on the generated or being produced content may comprise the size of the content and the type of the content (e.g., 2D/3D/VR/AR).

Referring to FIG. 22, information of elements comprised in generated or being produced content may be managed through a separate ID value (uuid), and the database may manage name and tag information of assets using the ID value, and through this, asset characteristics/characteristics of the content may be extracted.

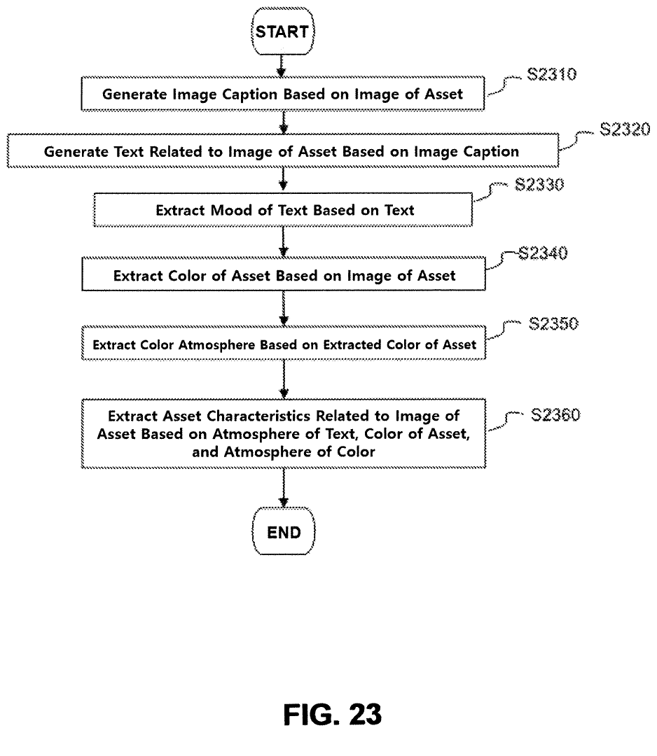

FIG. 23 is an example of asset property extraction to which the present specification may be applied.

Referring to FIG. 23, a method in which the recommendation device extracts the asset feature based on the image of the asset will be described in more detail. The image of the asset may be obtained from the database through the ID value of the asset described above. For example, the image of assets may be acquired through the database based on 1) history information of content used by the user through the platform, 2) information of components for content produced by the user, and 3) information on content currently being produced by the user.

The recommendation device generates an image caption based on the image of asset (S2310). Automatic image captioning is a technology that combines computer vision and natural language processing. Through this, the recommendation device may automatically generate a description or caption for the image of asset.

The recommendation device generates text related to the image of asset based on the image caption (S2320). The image caption generation may perform two main tasks of image recognition and natural language processing. For example, the recommendation device detects and recognizes an object, a scene, an attribute, and the like in the image of the asset by using an image recognition algorithm. Thereafter, the recommendation device may generate a text for the image using the natural language processing model. The generated text may be used as a caption describing the image of the asset.

Additionally, the recommendation device may process the text to enrich the information of the text. For example, the recommendation device may increase the amount of information of the text through a language model of the text and extract a keyword from the processed text.

The recommendation device extracts a mood of the text based on the text (S2330). For example, the recommendation device may extract the atmosphere through emotion analysis of text or processed text.

For example, emotion analysis may refer to a technology of recognizing and classifying emotions and emotions in data such as text, images, and voices. The recommendation device may perform a text emotion analysis using a Natural Language Processing (NLP) technology. To this end, various approaches and algorithms such as emotion dictionary, machine learning, and deep learning may be used.

The recommendation device extracts a color of the asset based on the image of the asset (S2340).

The recommendation device extracts a color atmosphere based on the extracted color of the asset (S2350). For example, the recommendation device may extract the mood of a color using an emotion analysis technique. For example, the color atmosphere may comprise values indicating brightness, medium, and dark, and for this purpose, a ColorThief library may be used.

The recommendation device extracts asset characteristics related to the image of the asset based on the atmosphere of the text, the color of the asset, and the atmosphere of the color (S2360). For example, the asset characteristic may comprise a numerical value that may be defined using a numerical value corresponding to the atmosphere of the text (e.g., positive or negative), the degree of the atmosphere of the color (e.g., bright or dark), and a numerical value corresponding to the degree of the color (e.g., brightness), corresponding to the ID value indicating the asset. Using the numerical values defined in this way, the asset can be classified.

The extracted characteristics of the asset may be stored and managed through a database.

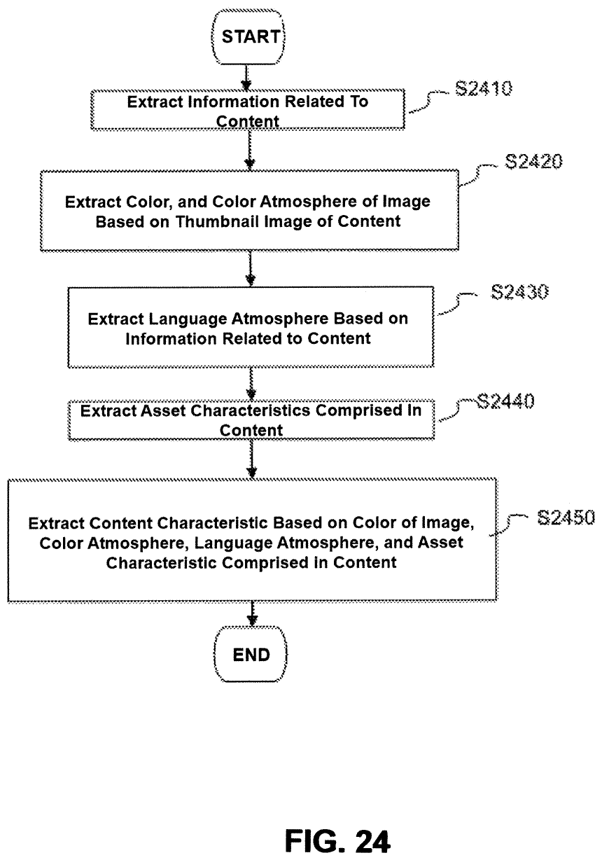

FIG. 24 is an example of content/template characteristic extraction to which the present specification may be applied.

Referring to FIG. 24, the recommendation device extracts information related to content (S2410). The recommendation device may extract information related to the content through the database. For example, the information related to the content may comprise information on the content described above with reference to FIGS. 19 and 20, information on components for the content produced by the user, and/or information on the content currently being produced.

The recommendation device extracts a color, and a color atmosphere of the image based on the thumbnail image of the content (S2420). For example, the recommendation device may extract the color of the thumbnail image and extract a mood of the color using emotion analysis technology.

The recommendation device extracts a language atmosphere based on the information related to the content (S2430). For example, the recommendation device may extract a language atmosphere from information (e.g., a content name, a description, a category, etc.) in a text form among information related to the content by using an emotion analysis technology.

The recommendation device extracts the asset characteristics comprised in the content (S2440). For example, the characteristics of the asset may be extracted through the operation of FIG. 23 described above, based on information of elements comprised in the content related to the thumbnail.

The recommendation device extracts a content characteristic based on a color of the image, a color atmosphere, a language atmosphere, and an asset characteristic comprised in the content (S2450).

For example, the content characteristic may comprise a numerical value that may be defined using a numerical value corresponding to a color (e.g., brightness) of a thumbnail image of the content, an atmosphere of the color (e.g., brightness, darkness), a degree of a language atmosphere (e.g., positive, negative), and the asset characteristic comprised in the content. Using the numerical value defined in this way, the content may be classified.

When the content is a specific template, the characteristics of the template may be extracted in the same manner. The extracted content and the characteristics of the template may be stored and managed through a database.

Referring back to FIG. 18, the recommendation device may generate characteristic data of the user by applying a weight to the extracted asset and content/template characteristics. For example, the weight may be applied using the user's behavior data that may indicate the user's preference for the corresponding asset, content/template, such as the user's number of plays, likes, and stay time.

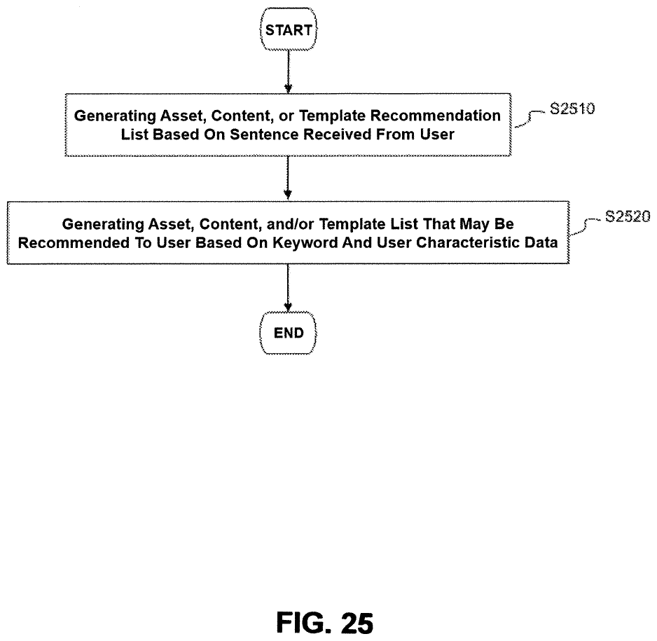

FIG. 25 is yet another embodiment of a recommendation device to which the present specification may be applied.

Referring to FIG. 25, the recommending device may input a keyword (e.g., an text field) and user characteristic data comprised in the sentence data of FIG. 15 described above to the keyword matching system to generate an asset, content, or an template list.

The recommendation device generates a keyword for generating an asset, content, or a template recommendation list based on a sentence received from the user (S2510). For example, the recommendation device may receive an input of a sentence for recommending asset, content, or template through the terminal from the user, and generate a keyword for recommending asset, content, or template based on the operation of FIG. 15.

Based on the keyword and the user characteristic data, an asset, content, and/or template list that may be recommended to the user is generated (S2520).

For example, the recommendation device may generate the user characteristic data based on history information of content used by the user through the platform, information of components for content produced by the user, and information about content currently being produced by the user. In addition, the keyword may be associated with language-based data comprised in the asset, content, and/or information related to the template. Based on the correlation, the recommendation device may generate an asset, content, and/or a template list that may be recommended to the user based on the preference based on the user characteristic data.

Table 2 below illustrates an asset, content, and/or template list that may be recommended to a user.

TABLE 2
{
″original″: ″ [symbol] [symbol] [symbol] ″,
″sentence″: ″

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

″,
″contentList″: [
″a7e884bb-3d4c-46e2-9cf9-640460eb44d0″,
″a7e884bb-3d4c-46e2-9cf9-640460eb44d0″,
″a7e884bb-3d4c-46e2-9cf9-640460eb44d0″,
″a7e884bb-3d4c-46e2-9cf9-640460eb44d0″,
...
],
″TemplateList″: [
″a7e884bb-3d4c-46e2-9cf9-640460eb44d0″,
″a7e884bb-3d4c-46e2-9cf9-640460eb44d0″,
″a7e884bb-3d4c-46e2-9cf9-640460eb44d0″,
″7e884bb-3d4c-46e2-9cf9-640460eb44d0″,
...
],
″assetList″: [
{
″assetIdx″: ″0b70763b-4e22-43bb-a163-68c80f9b9e37″,
″metaData″: {
″words″: [
{
″text″: ″ [symbol] ″',
″english″: ″sky and″,
″classification″: ″ [symbol] ″,
″english_classification″: ″noun″,
″importance″: 3,
″part_of_speech″: ″NNG″
},
{
″text″: ″ [symbol] ″,
″english″: ″grass with″,
″classification″: ″ [symbol] ″,
″english_classification″: ″noun″,
″importance″: 3,
″part_of_speech″: ″NNG″
},
{
″text″: ″ [symbol] ″,
″english″: ″smile and″,
″classification″: ″ [symbol] ″,
″english_classification″: ″noun″,
″importance″: 3,
″part_of_speech″: ″NNG″
}, ...
]
}
},
{
″assetldx″: ″0b70763b-4e22-43bb-a163-68c80f9b9e37″,
″metaData″: {
″words″: [
{
″text″: ″ [symbol] ″,
″english″: ″dancing″,
″classification″: ″ [symbol] ″,
″english_classification″: ″verb″,
″importance″: 3,
″part_of_speech″: ″VV+ETM″
},
{
″text″: ″ [symbol] ″,
″english″: ″green″,
″classification″: ″ [symbol] ″,
″english_classification″: ″adjective″,
″importance″: 3,
″part_of_speech″: ″VA″
},
{
″text″: ″ [symbol] ″,
″english″: ″grass″,
″classification″: ″ [symbol] ″,
″english_classification″: ″noun″,
″importance″: 3,
″part_of_speech″: ″NNG″
}, ...
]
}, ...
}
]
}

Referring to Table 2, the list that may be recommended to the user may comprise a sentence input from the user, a story based on the sentence, a content list, a template list, and/or an asset list, and the asset list may comprise metadata of the asset.

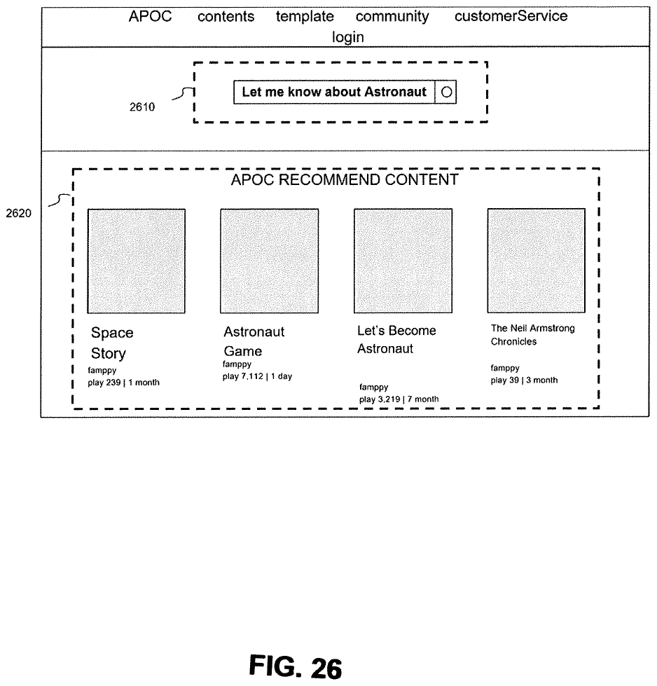

FIG. 26 is an example of a platform to which the present specification may be applied.

Referring to FIG. 26, the user may search for desired content as a sentence in a content main screen search window 2610 displayed through the platform, and the recommendation device may recommend and display content based on a keyword of an input sentence and user characteristic data 2620. The asset, template recommendations may be performed in the same manner.

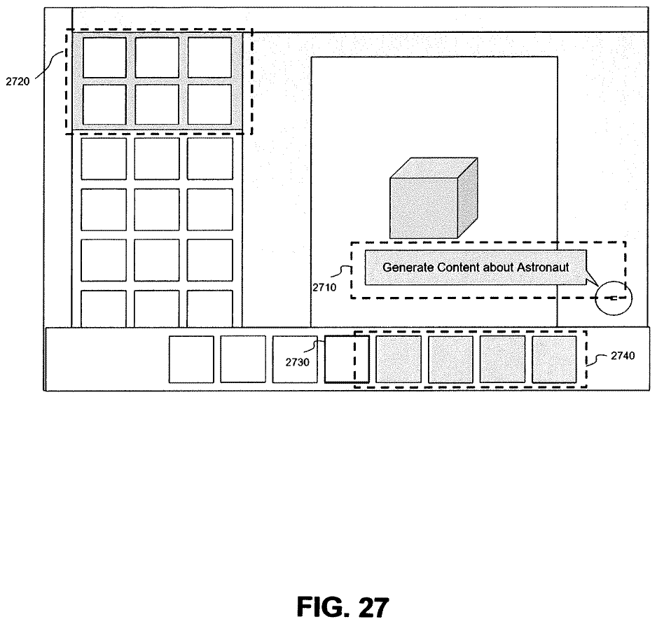

FIG. 27 is an example of a convergence manufacturing device to which the present specification may be applied.

Referring to FIG. 27, a user may be provided with a content production screen from the convergence manufacturing device through a terminal. The user may input 2710 sentences for content production on the content production screen. The recommendation device may recommend and display asset based on the keyword of the input sentence and the user characteristic data 2720, and the recommended content/template may be displayed after the canvas 2730 in which the user is currently located 2740.

The above-described present specification may be implemented as computer-readable codes in a medium in which a program is recorded. The computer-readable medium comprises all kinds of recording devices in which data readable by a computer system is stored. Examples of the computer-readable medium comprise a hard disk drive (HDD), a solid state disk (SSD), a silicon disk drive (SDD), a ROM, a RAM, a CD-ROM, a magnetic tape, a floppy disk, an optical data storage device, and the like, and also comprise a device implemented in the form of a carrier wave (e.g., transmission over the Internet). Accordingly, the above detailed description should not be construed as limiting in all respects and should be considered as illustrative. The scope of the present specification should be determined by reasonable interpretation of the appended claims, and all changes within the equivalent scope of the present specification are comprised in the scope of the present specification.

In addition, although the above description has been made based on the services and embodiments, this is merely an example and does not limit the present specification, and it will be appreciated by those skilled in the art that various modifications and applications that are not illustrated above may be made without departing from the essential characteristics of the services and embodiments. For example, each component specifically shown in the embodiments may be modified and implemented. In addition, the differences related to such modifications and applications should be interpreted as being comprised in the scope of the present specification defined in the accompanying claims.

1. A method for recommending an asset, content, or template to a user by a recommendation device, comprising:
receiving, an input of the asset, the content, or a sentence for recommending the template from the user;
generating, a keyword for recommending the asset, the content, or the template based on the sentence;
generating, user characteristic data based on 1) history information of content used by the user through the platform, 2) information of components for the content produced by the user, and 3) information on content currently being produced by the user; and
generating, a list of the asset, the content, or the template that may be recommended to the user, based on the keyword and the user characteristic data.

2. The method of claim 1,
wherein the generating user characteristic data comprises:
acquiring, an image of the asset based on the history information of the content, the information on the components of the content produced by the user, and the information on the content currently being produced by the user;
generating, an image caption based on the image of the asset;
generating, text related to the image of the asset based on the image caption;
extracting, an atmosphere of the text based on the text;
extracting, a color based on the image of the asset;
extracting, an atmosphere of the color based on the extracted color;
extracting, asset characteristics associated with the image of the asset based on the atmosphere of the text, the color, and the atmosphere of the color; and
generating, the user characteristic data based on the asset characteristic.

3. The method of claim 2, further comprising:
extracting, a language atmosphere based on the history information of the content, information on the components of the content produced by the user, and information on the content currently being produced by the user, and obtaining a thumbnail image;
extracting, a color of the thumbnail image and an atmosphere of the color based on the thumbnail image;
extracting, asset features comprised in the content related to the thumbnail;
extracting, a content characteristic based on the language atmosphere, the color of the image, the atmosphere of the color, and the asset characteristic comprised in the content related to the thumbnail; and
generating, the user characteristic data based on the content characteristic.

4. The method of claim 3,
wherein the generating of the keyword comprises:
converting, the sentence into a story-type text through a language model;
converting, the writing of the story forms into a synopsis including 1) a background, 2) a main character, and 3) a main element through the language model;
converting, the synopsis into sentence data associated with language-based data comprised in the asset, the content, or the information related to the template through the language model; and
generating, the keyword based on the sentence data.

5. The method of claim 3, further comprising:
applying, a weight related to the user's preference to the asset characteristic and the content characteristic; and
generating, the user characteristic data based on the weight.

6. The method of claim 1, further comprising:
displaying, a list of the asset, the content, or the template to the user via the platform.

7. The method of claim 1, further comprising:
displaying, the asset, the content, or the list of the template to the user through the convergence creation device.

8. A recommendation device for recommending assets, content, or template to a user, comprising:
a communication unit;
a memory including a language model; and
a processor for functionally controlling the communication unit and the memory, and
said processor is configured to:
receive, from the user, a sentence for recommending the asset, the content, or the template, and generate a keyword for recommending the asset, the content, or the template, based on the sentence,
generate, user characteristic data, based on 1) history information of content used by the user through the platform, 2) information of components for the content produced by the user, and 3) information on content currently being produced by the user, and
generate, a list of the asset, the content, or the template that may be recommended to the user based on the keyword and the user characteristic data.
